(19) United States
(12) Patent Application Publication
(10) Pub. No.: US 2011/0260612 A1
(43) Pub. Date: Oct. 27, 2011

(54) PLASMA DISPLAY DEVICE, GLASS FILTER FOR THE PLASMA DISPLAY DEVICE AND MANUFACTURING METHOD FOR THE GLASS FILTER

(76) Inventor: Gol-Hee Lee, Seoul (KR)

(21) Appl. No.: 13/060,507

(22) PCT Filed: Dec. 22, 2008
(86) PCT No.: PCT/KR08/07590

§ 371 Date: Jul. 7, 2011

(30) Foreign Application Priority Data
Aug. 25, 2008 (KR) 10-2008-0082841

(51) Int. Cl. H01J 17/16; B32B 37/14; B32B 37/12; F21V 9/04; B32B 37/02

(52) U.S. Cl. 313/635; 359/359; 156/60

(57) ABSTRACT

In order to optimally implement functions of a glass filter and reduce manufacturing costs by reducing a defective rate of a plasma display device, the present invention provides a plasma display device comprising: a plasma display module; a frame supporting the plasma display module; a glass filter on whose rear the frame is fixed; and a rear housing protecting the plasma display module in the rear thereof, wherein the glass filter comprises: a substrate: a functional film layer on whose external surface a black frame layer defining an effective screen is formed; a pressure sensitive adhesive layer adhering the functional film layer to the substrate; and an electromagnetic waves shielding layer provided in the rear of the substrate and blocking electromagnetic waves generated from the plasma display module to transfer it to the frame.

### TECHNICAL FIELD

The present invention relates to a plasma display device, a glass filter for the plasma display device and a manufacturing method for the same.

### BACKGROUND ART

In a plasma display panel, a plurality of cells are provided by means of a plurality of barrier ribs formed between a front panel and a rear panel formed of glass. In each cell, inert gases such as He—Xe and He—Ne, etc. are injected. And, when a discharge phenomenon occurs in the cells by means of high frequency voltage, vacuum ultraviolet rays are generated to light-emit phosphors provided between the barrier ribs.

A plasma display device includes a case, the plasma display panel (hereinafter, referred to ‘PDP’), a driving circuit including a PCB for controlling the driving of the PDP, and a heat sink connected to a substrate of the driving circuit and radiating heat generated when driving the plasma display device. The plasma display device may further include a filter formed on the front surface of the PDP.

The filter performs a color correction function to correct deterioration of color purity generated due to a problem occurred by a peculiar operation manner of the PDP, a function to block mal-function of external equipments such as a remote controlling equipment, and a function to shield ultraviolet rays that is harmful to a human body and causes mal-function of the equipment. Furthermore, the filter performs an antireflection function to prevent an external light in order to solve a problem that a viewer feels due to reflection of the external light, and a function to set a black frame defining an effective screen in order to provide a convenience for viewing.

As the filter, there are a glass filter type in which a plurality of films performing each function are stacked in the glass, and a film type in which a plurality of films are stacked on a front panel of the PDP. Problems arise in the film type that errors may occur in the PDP with high manufacturing costs when handling it due to the process problem of the film type that the plurality of films are spontaneously stacked, functional efficiency required as conditions is deteriorated due to use of only thin films, and ground is not efficiently made. To the contrary, the glass filter type, which uses a separate glass filter, has a disadvantage that a manufacturing cost is increased compared to the film type, however has advantages that since a gap is formed between the PDP, functions required in the filter are completely implemented, and since the film can be implemented apart from the high-cost PDP, a defective rate of the display equipment generated during a production process can be reduced.

Under the circumstance, the present invention relates to a plasma display device using a glass filter and a glass filter for the plasma display device.

Korean Patent Application No. 10-2007-0054205 (cited reference 1) filed on Jun. 4, 2007 by the present applicant discloses the plasma display device using the glass filter. The cited reference 1 discloses a front panel (see 11 of FIG. 3 in cited reference 1) as the constituent corresponding to the glass filter. In cited reference 1, the front panel 11 forms a front external appearance and a separate injection-molded product for fixing the front panel 11 is not provided. However, cited reference discloses that a black frame layer indicated as a opaque film layer 111 is coated directly on a rear surface or a front surface of the front panel 11 (see the 5th paragraph of the exemplary embodiment). However, it is not preferable that the black frame layer is coated directly on one surface of the glass, since it may be in danger of breaking glass during the coating process. Furthermore, cited reference 1 fails to totally disclose various functions implemented by the glass filter, that is, cited reference 1 does not absolutely disclose how an electromagnetic waves shielding function, a color correction function, an near infrared ray blocking function, and an external light reflection function, etc., are implemented.

Meanwhile, the glass filter is expensive so that it occupies over 30% of the entire manufacturing cost of the plasma display device, excepting the PDP. Considering such a problem, the main target of the present invention is that how a desired effect can be implemented by using which type of filter, while reducing the manufacturing cost. Such a cost becomes more significant when the competition between the plasma display device and a liquid crystal display device has been intensified.

As the prior art of the glass filter, there is Korean Patent Laid-Open Publication No. 10-2005-0106622 (cited reference 2) in which a black frame is spontaneously formed in glass in order to define effective screen. However, the glass filter of the prior art in cited reference 2 has problems in that since the black frame is formed in the glass, and separate filters are required in order to perform an electromagnetic waves shielding function, a color correction function, an near infrared ray blocking function, and an external light reflection function, a high cost and a complicated process is required. Meanwhile, cited reference 2 discloses a film type to be attached to a upper of an electromagnetic waves shielding film, differently from the glass filter type. However, this film type is also a film type to lead to a complicated manufacturing type and further a plurality of films are stacked to lead to many disadvantages in view of a manufacturing process and a cost. Cited reference 2 also discloses a film type using an electromagnetic waves shielding layer. However, this film type combines an electromagnetic waves shielding layer and a color dye layer so that it is difficult to control the process thereof, thereby causing problems of a complicated process and an increase in costs accordingly. This film type also has a problem of the film type as it is.

There is also a technique proposed by Korean Patent Laid-Open Publication No. 10-2005-0051844 (cited reference 3). In the technique, a film is made of photosensitive material and the film is emitted by ultraviolet rays to spontaneously act as a black frame. However, in such a technique, a separate photosensitive process should be needed to lead to an increase in costs and all other films should be stacked sequentially to lead to an increase in processes and costs.

### DISCLOSURE OF INVENTION

### Technical Problem

An object of the present invention is to provide a glass filter having a structure to form a front surface of a plasma display device, in which a black frame is efficiently manufactured and each necessary function of the glass filter is implemented by an optimal functional layer. Thereby, an object of the present invention is to provide a plasma display device capable of accomplishing a reduction of manufacturing costs of a glass filter, an advantage of processes, and a reduction of a defective rate, and a glass filter for the plasma display device.

### Technical Solution

In order to accomplish the objects, according to a first invention, there is provided a plasma display device comprising: a plasma display module; a frame supporting the plasma display module; a glass filter on whose rear the frame is fixed; and a rear housing protecting the plasma display module in the rear thereof, wherein the glass filter comprises: a substrate: a functional film layer on whose external surface a black frame layer defining an effective screen is formed; a pressure sensitive adhesive layer adhering the functional film layer to the substrate; and an electromagnetic waves shielding layer provided in the rear of the substrate and blocking electromagnetic waves generated from the plasma display module to transfer it to the frame.

According to a second invention, there is provided a glass filter of a plasma display device, which is spaced forward from a plasma display module at a predetermined distance to perform a color correction function correcting deterioration of color purity, a near infrared ray blocking function blocking a near infrared ray generating malfunction of a remote controller, etc., an electromagnetic waves shielding function, an external light antireflection function, and a function defining an effective screen, wherein the function defining the effective screen is performed by a functional film layer on whose external region a black frame layer is printed, the functional film layer being attached to the front surface of the substrate using an adhesive.

According to a third invention, there is provided a manufacturing method of a glass filter of a plasma display device, in which a burning process of a substrate and a pattern provided by printing the substrate is performed at a once and a printing process of a black frame layer on one surface of a functional film layer is performed, respectively, and the functional film layer is adhered to the substrate so that the electromagnetic wave shielding layer provided by the burning the pattern faces the rear.

### ADVANTAGEOUS EFFECTS

The present invention is advantageous in that although various functions required in the glass filter are optimally implemented, the costs thereof can be reduced, and the defective rate of the plasma display device can be reduced as a whole.

More specifically, the glass file can be provided only with the functional film layer, the substrate and the pressure sensitive adhesive, such that the present invention is advantageous in view of the simple process and the manufacturing costs thereof. Also, the electromagnetic waves shielding layer s provided in the bottom-most and the innermost of the glass filter so that subsequent processes such as a ground, etc. can be conveniently performed, and although a front boundary portion of the front display device is protected directly by the glass filter, without a front frame, processes such as the ground, etc. can be conveniently performed. Also, the black frame layer is simply and conveniently performed through a process that it is printed on the bottom surface of the functional film layer, such that the present invention is advantages in view of the manufacturing costs and the manufacturing processes.

Also, the plasma display device can be more popularized due to low manufacturing costs thereof.

### BRIEF DESCRIPTION OF DRAWINGS

The above and other objects, features and advantages of the present invention will become apparent from the following description of preferred embodiments given in conjunction with the accompanying drawings, in which:

FIG. 1 is a perspective view of a plasma display device according to the present invention;

FIG. 2 is a cross-sectional view taken along lines I-I′of FIG. 1;

FIG. 3 is an exploded perspective view of a plasma display device according to the present invention;

FIG. 4 is a cross-sectional view of a first embodiment of a glass filter according to the present invention;

FIG. 5 is a flowchart explaining a manufacturing method of a glass filter according to a first embodiment;

FIG. 6 is a cross-sectional view of a second embodiment of a glass filter according to the present invention;

FIG. 7 is a cross-sectional view of a third embodiment of a glass filter according to the present invention; and

FIG. 8 is a cross-sectional view of a fourth embodiment of a glass filter according to the present invention.

### MODE FOR THE INVENTION

Preferred embodiments of the present invention will be described in detail with reference to the accompanying drawings.

In describing the idea of the present invention, first, a plasma display device will be described and then a glass filter for the plasma display device will be described.

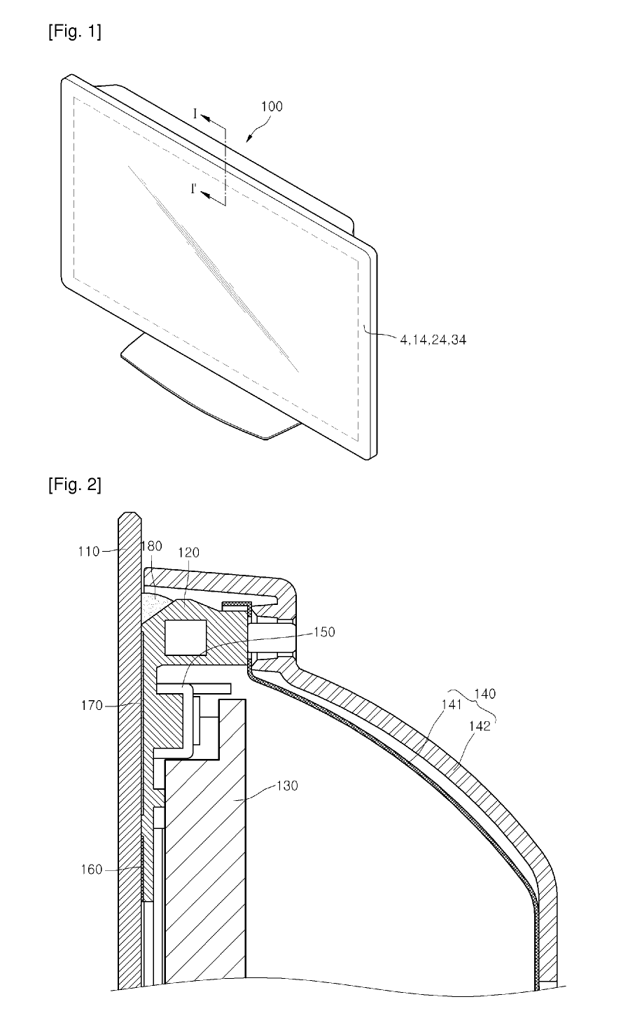

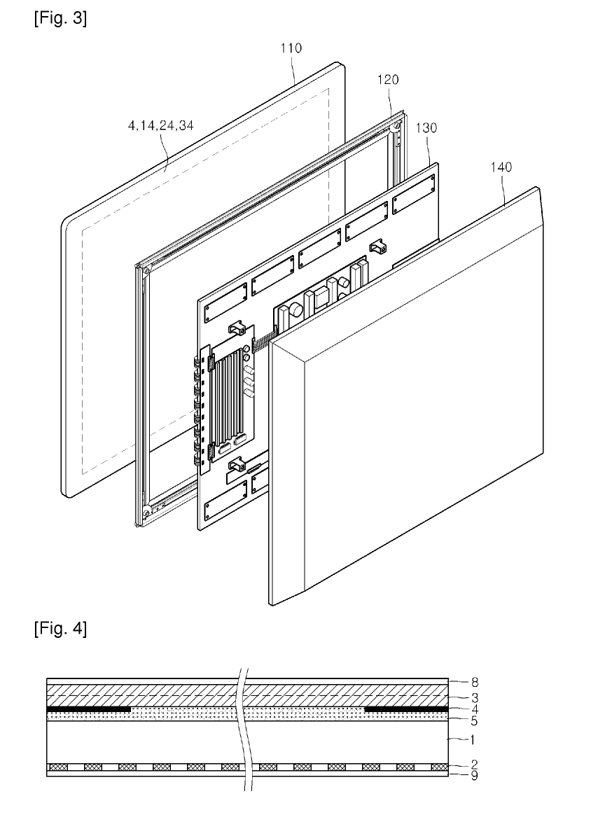

FIG. 1 is an external perspective view of a plasma display device according to the present invention, FIG. 2 is a cross-sectional view taken along lines I-I′ of FIG. 1, and FIG. 3 is an exploded perspective view of a plasma display device according to the present invention.

Referring to FIGS. 1 to 3, the plasma display device 100 includes a PDP 130 outputting an image, a glass filter 110 protecting a front surface of the PDP 130, a frame 120 whose front surface is closely adhered to the glass filter 110, and rear surface is fixed to the PDP 130, a bracket 150 connecting the frame 120 to the PD 130, and a rear housing 140 coupled to a rear of the glass filter 110 to surround and protect the PDP 130.

In detail, a pressure sensitive adhesive member 170 is interposed between the glass filter 110 and the frame 120 to allow the frame 120 to be fixed to the glass filter 100. And, a gasket 160 for blocking electromagnetic waves is interposed between the glass filter 110 and the frame 120. The pressure sensitive adhesive member 170 and the gasket 160 are provided, respectively, on the positions spaced at a predetermined interval. The gasket 160 is inserted between an electromagnetic waves shielding layer 2 to be described later and the frame 120 to allow electromagnetic wave absorbed into the electromagnetic waves shielding layer 2 to be emitted to the frame 120. The gasket 160 may not be provided, if the contact reliability between the frame 120 and the electromagnetic waves shielding layer 2 is excellent.

Black frame layers 4, 14, 24, and 34 defining an effective screen of the glass filter 110 are formed on the boundary of the glass filter 110. In detail, the providing structure and method of the black frame layer 4, 14, 24, and 34, which form one feature of the present invention, will be explained when explaining a glass filter. And, the frame 120 is arranged in front and rear of the black frame layers 111 to allow the frame 120 not to be shown from the front of the display device 100.

A sealing member 180 is applied to the upper part of the front surface of the frame 120 to prevent the inflow into the gap between the frame 120 and the glass filter 110. And, the frame 120 is put along the rear boundary of the glass filter 110.

The rear housing 140 covering and protecting the PDP 130 includes an inner housing 141 whose front boundary part is closely adhered to the frame and made of conductive material, and an outer housing 142 covering the inner housing 141. However, the rear housing 140 is not always formed using two but may be formed using one conductive cover. The rear housing 140 is engaged into the frame 120 to protect the PDP 130 in the rear direction.

Here, the electromagnetic waves emitted from the PDP 130 flows onto an EMI grounding gasket 160 attached to the front surface of the frame 120, and the frame 120. And, the electromagnetic waves flowing onto the frame 120 are transferred to the rear housing 140. Therefore, the frame 120 is preferably made of conductive material, wherein aluminum material may be proposed by way of example. However, the material of the frame 120 is not limited to the aluminum material but any conductive material can be applied.

Here, the frame 120 may be manufactured using nonconductive material, for example, ejection-molded material. In this case, a separate ground structure for grounding electromagnetic waves is required.

In the plasma display device of the present invention, the glass filter 110 itself entirely covers the front surface of the plasma display device, and the glass filter 110 defines the upper-front surface of the plasma display device. And, a separate supporting frame for spontaneously supporting the glass filter 110 is not provided in the boundary part of the glass filter 110. Therefore, only the glass filter 110 is shown from the front of the plasma display device. Thereby, the external appearance of the plasma display device becomes beautiful and the material costs are more reduced. In view of a viewer, there is an advantage that the effective screen of the plasma display device looks larger than its actual size. However, the glass filter 110 capable of faithfully performing such functions should be prepared. For example, the electromagnetic waves shielding layer of the glass filter 110 should be put on the inner-most side of the glass filter, and the black frame layer thereof should be provided on the exact position of the boundary part of the glass filter, having an exact area.

Hereafter, various embodiments of the glass filter proposed in order to faithfully perform functions as described above will be described.

In the description hereinafter, although glass filter is shown using a single substrate in FIGS. 1 to 3, however this is because that the substrate occupies most thickness of the glass filter. In fact, various layers reaching thickness of micrometers are formed in front and rear of the substrate, as shown in the drawings hereafter. Although the thickness of the substrate is illustrated to be remarkably small in the drawings hereafter, this is for convenience of explanation for each layer. In fact, the substrate occupies the most thickness, as shown in FIG. 2.

### FIRST EMBODIMENT

FIG. 4 is a cross-sectional view of a glass filter for a plasma display device of a first embodiment.

Referring to FIG. 4, on a lower side of the glass filter, an electromagnetic waves shielding layer 2 and a rear surface protective film 9 are put, based on a substrate 1. And, on a upper side of the glass filter, a pressure sensitive adhesive layer 5, a black frame layer 4, a functional film layer 3, and a front surface protective film 8 are put sequentially. The black frame layer 4 in a state where it is stacked on a lower side of the functional film layer 3 using a printing method, etc., is attached to the substrate 1 by means of the pressure sensitive adhesive layer 5. The front surface in the front surface protective film 8 means a user side, that is, an external side of the plasma display device, and the rear surface in the rear surface protective film 9 means an inner side of the plasma display device.

The material of the respective layers as described above and the relationship between the respective layers will be described in more detail.

### Electromagnetic Waves Shielding Layer

The electromagnetic waves shielding layer 2, which is formed in a rear surface of the substrate 1 made of glass having a high light transmittance, performs a function to shield the electromagnetic waves emitted from the PDP not to be leaked to the external.

The electromagnetic waves shielding layer is formed by patterning metal having relatively low resistance, such as silver, gold, platinum, and copper, etc.,—preferably, silver—in a mesh type or in a stripe type. It is preferable that the respective lines forming the patterned electromagnetic waves shielding layer has line widths of 10-30 micrometers, for electromagnetic waves shielding effects and the light transmissivity.

As a method to pattern the electromagnetic waves shielding layer, an off-set device can be applied for the convenience of processes and reduction of material costs.

The off-set device is divided into a transition part, a conveyor, and a transfer part.

The transition part includes a transition roll having grooves with an interval and a depth corresponding to the pattern of the electromagnetic waves shielding layer and made of metal/rubber/synthetic resin, as a main constitution. On one side of the transition roll, a nozzle for injecting shielding material forming the electromagnetic waves shielding layer to the grooves, and a blade for planarizing the injected shielding material on the transition roll are provided. With the constitution as described above, the shielding material is injected to the external surface of the rotating transition roll through the nozzle and then, the shielding material is planarizingly injected to the grooves using the blade.

Thereafter, the transition roll is pressively contacted to the conveyor in at least one portion thereof so that the pattern of the shielding material is transitioned to the conveyor in the contacted portion.

Thereafter, the conveyor is moved to the transfer part, and the transfer part allows the conveyor to be pressively contacted to the substrate 1 in at least one portion thereof so that the pattern of the shielding material is transferred to the substrate in the contacted portion.

Meanwhile, the shielding material in a state where solvent is contained in metal material, etc. forming the electromagnetic waves shielding layer—preferably, silver—, has flowability to some extent. The shielding material having flowability is discharged from the grooves of the transition roll and is then transitioned to the conveyor to be [an off state], so that the shielding material contact air to have viscosity. And, the shielding material contacts the substrate 1 and then is transferred to be [a set state].

After the shielding material is transferred to the substrate 1 by means of the off-set device, the shielding material is subject to a burning process so that solvent is removed and at the same time the electromagnetic waves shielding layer is hardened. Through the process as described above, an electromagnetic waves shielding layer having a pre-determined pattern is integrally formed on the rear surface of the substrate 1.

Meanwhile, during the burning process, an advantage that the glass forming the substrate 1 is also hardened can be expected. In other words, through a single burning process, a hardening process of the glass forming the substrate and the burning process of the electromagnetic waves shielding layer can also be performed simultaneously. Thereby, comparing to the prior art where the burning process is performed twice, more enhanced effects on reduction in manufacturing processes and manufacturing costs can be expected.

### Pressure Sensitive Adhesive Layer

The pressure sensitive adhesive layer 5 is a pressure sensitive adhesive (PSA) having adhesive power by reacting to pressure. As the adhesive material of the pressure sensitive adhesive layer 5, acrylic based pressure-sensitive adhesive having excellent adhesive power and durability is used as a binder, color correction dye performing a color correction function, near infrared ray blocking dye blocking near infrared ray, and a solvent are used. A crosslinking agent and a coupling agent may further used, together with the binder.

The acrylic based adhesive used as the binder can be obtained through a single or a copolymerization by mixing 75-99.89 wt % of (metal)acrylic acid ester monomer having carbon number 1 to 12 in the alkyl group, 0.1-20 wt % of α and β unsatured carboxylic acid monomers, which are functional monomers, or 0.01 5 wt % of polymerizable monomer having hydroxyl group. As the color correction dye, at least one of porphyrin based dye and cyanine based dye may be used. As the near infrared ray blocking dye, at least one of deionium based dye, phthalocyanine based dye, and naphthalocyanine based dye.

The pressure sensitive adhesive layer 5, which is provided with the color correction dye and the near infrared ray blocking dye, allows a color correction function and a near infrared ray blocking function to be performed by a single layer, as proposed above.

Here, a weight ratio between the binder and binder has preferably a range of 10:1 10000:1, however it may be varied according to transmissity, or extent of absorption coefficient, final viscosity of adhesive, color correction and near infrared ray blocking, etc.

The pressure sensitive adhesive layer 5 is interposed between the front surface of the substrate 1 and a functional film layer 3 to perform a function to attach the substrate 1 to the functional film layer 3, and a color correction function and a near infrared ray blocking function by means of the color correction dye and near infrared ray blocking dye included in the adhesive material.

### Functional Film Layer

The functional film layer provides a method to further provide a hard coating layer on a plastic film—preferably, PET—, as a hard film layer.

The method to provide the hard coating layer will be described in more detail.

Coating liquid is coated on a poly ethylene terephtahlate (PET) film layer using a solgel process—preferably, a spin coating process—and then is dried.

Here, as the coating liquid, a mixture liquid of poly(2-methyl-2-oxazoline), poly(N-vinylpyrrolidone) and polyethylene glycol in which is evenly contained in molecule units in silica gel, a mixture liquid of SiO₂, C₆H₅SiO_{3/2}, and polyethylene glycol, and a mixture liquid of tetrathoxysilane (TEOS), phenyltriethoxysilane (PhTEOS), C₂H₅OH, H₂O, and HCl.

The hard coating layer prepared by the method as described above may have a high bond strength, a high flexibility, a high strength standing against physical stimulus from the external, and a higher light transmittance compared to the light transmittance of the PET itself. Here, the reason why the hard coating layer has a higher light transmittance compared to the light transmittance of the PET itself is that the hard coating layer has a low light reflection coefficient, wherein the low light reflection coefficient is resulted from that the coating layer has silica as a main component. Therefore, the hard coating layer can remarkably lower the manufacturing costs compared to an AR film manufactured using an antireflection layer through a deposition, etc. in the prior art. The present invention does not exclude the feature that the AR film and an AG film are used form the invention idea, however an advantage that the manufacturing costs of the glass filter are remarkably reduced when the hard film layer is used can also be expected.

In the drawing, the dotted line of the functional film layer 3 is a line that is a base distinguishing the film layer from the coating layer.

### Black Frame Layer

The black frame is a portion to process the boundary portions of the plasma display device corresponding to the portions other than the effective screen in black.

The black frame layer 4 is manufactured by being printed on the rear surface of the functional film layer 3. Here, as the printing method, a screen printing method or a gravia printing method may be used. Through the method to paint the rear surface of functional film layer with coatings added with black pigments or dyes at a thin thickness as described above, costs rendered in manufacturing the black frame layer are remarkably reduced. However, the printing method is not particularly limited to the method as described above.

For example, compared to the case where the black frame layer is formed directly on the glass as described in cited reference 2, the costs and time required in the burning process can be reduced and the concern that dirt is stuck to the glass can be reduced. Compared to another technique in cited reference 2, the black frame layer can be formed on the glass through a simple process. Compared to the case where the film made of photosensitive material is used as shown in cited reference 3, the photo-sensitive film is not required so that the costs can be reduced considerably. Also, compared to the case where a special work is required for forming the black frame layer on the adhesive, the convenience of the work and the reduction of the process resulted therefrom can be increased.

### Protective Film Layer

The protective film layers 8 and 9, which are to resist against the dirt or impact that may occur during the manufacturing process and conveying process of the glass filter, and the manufacturing process of the plasma display device, can be easily removed during a final process, wherein a thin film made of polypropylen or polyethelene can be used.

The protective film layers do not affect the substantial operation of the glass filter so that they may be excluded from the constituents of the glass filter unless there is a special remark.

The operation of the glass filter according to the first embodiment will be described.

The electromagnetic waves generated from the PDP are shielded by the electro-magnetic waves shielding layer 2 to be removed through a ground part of the plasma display device. The color correction function and the near infrared ray blocking function are accomplished by the pressure sensitive adhesive layer 5. The external light antireflection function is performed by the functional film layer 3. And, the effective screen of the plasma display device may be defined by the black frame layer 4.

According to the glass filter of the present embodiment, the glass film can be provided only with the functional film layer, the substrate, and the adhesive, making it possible to simplify the process and obtain many advantages in view of the manufacturing costs. Also, the electromagnetic waves shielding layer is provided on the bottom-most side of the glass filter—the innermost side seen from the display device—, making it possible to conveniently perform subsequent processes such as a grounding process, etc., and to perform the grounding process even though the glass filter directly protects the front boundary portions of the display device, without the front frame. Also, the black frame layer can be provided on the exact position with the exact area through a process that it is printed on the bottom surface of the functional film layer and furthermore, can be simply and conveniently manufactured through the printing method, making it possible to expect advantages in view of the manufacturing costs and manufacturing processes.

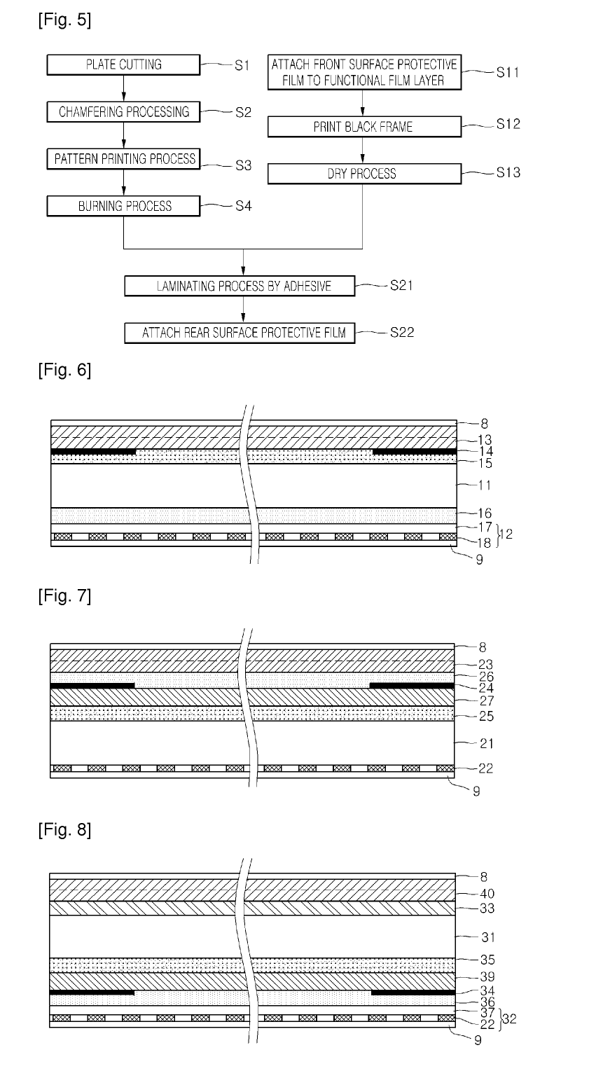

FIG. 5 is a flowchart explaining a manufacturing method of a glass filter according to the first embodiment.

Referring to FIG. 5, with the manufacturing method of the glass filter according to the present invention, both components on a substrate 1 side and components on a functional film layer 3 side each are subject to an independent manufacturing process.

First, a large glass of the substrate 1 is cut (S1) and boundary portions of the cut plate is chamfered (S2). The chamfering process (S2) is for preventing the boundary portions from being obstacle in viewing when the glass filter itself provides the front boundary portions of the display device without a separate front frame. Therefore, after the chamfering process (S2) is performed, the boundary portions of the substrate 1 become glossy or semi-glossy and thereby, a phenomenon to have an influence on viewer's eyes such as intensive reflection, etc., disappears.

Thereafter, a pattern is printed using shielding material forming the electromagnetic waves shielding layer 2 (S3). An off-set printing can be used in the pattern printing, as already described above. The pattern is heated in a heating furnace (S4) after being printed to perform a burning process on the shielding material forming the electro-magnetic waves shielding layer and simultaneously to perform a hardening process on the substrate 1. The burning process of the shielding material and the hardening process of the substrate can be performed at the same time so that the process can be more simplified and the material costs can be more reduced.

In the manufacturing process of the components on the substrate 1 side as described above, the chamfering process (S2) can be removed when the substrate 1 does not form the boundary portions in the plasma display device.

In the manufacturing process of the components on the functional film 3 side, the front surface protective film 8 is attached to the functional film layer 3 (S11). Thereafter, paint providing the black frame layer 4 is printed (S 12) and a dry process of the printed paint is performed (S13).

Here, the attaching process of the front surface protective film 8 may be performed after the black frame printing process (12) or the dry process (S13), however it is preferable that it is performed before the paint forming the black frame is printed in order to protect the film.

The components on the functional film side and the components on the substrate side are conveyed, through each process described above, to a spot where the glass filter is manufactured. In the spot where the glass filter is manufactured, they are combined as the components on the functional film side is laminated into the components on the substrate side in a state where the pressure sensitive adhesive layer is interposed therebetween (S21). After the engagement of the both components is completed, the rear surface protective film 9 is attached to the surface where the electromagnetic waves shielding layer 2 is provided (S22). Here, the rear surface protective film attaching process (S22) may be performed after the burning process (S4), however in that case, it is difficult to attach the rear surface protective film due to remaining heat during the heating process so that it is not preferable. After a sufficient cooling process is performed, it is preferable that the rear surface protective film is previously attached, such that the rear surface protective film can be attached before the components on the substrate side is conveyed.

The manufacturing method of the glass filter described above is completed by attaching the components on the substrate side and the components on the functional film side, being completed, one time using adhesive. Therefore, there is an advantage that the deterioration of the production yield that may occur in the case where the glass filter goes through a plurality of processes can be prevented. For example, when a plurality of films are stacked on the substrate, the substrate is laid to be left idle for a long time or a change in conveying and positioning. In this case, there are much concerns that dirt is stuck to the substrate, damage is generated in the wires of the electromagnetic waves shielding layer or the substrate may be broken. Differently therefrom, with the present embodiment, all processes are completed by attaching the components on the functional film layer side to the substrate one time, a tact time of the process is reduced, making it possible to improve yield of the product and to reduce a process time.

In the present invention, another embodiments variable other then the exemplary embodiment described above can be further included. In the embodiments to be described hereinafter, the constitution remarkably distinguished from the first embodiment will be described and the description proposed in the first embodiment will be cited for the same portions.

### SECOND EMBODIMENT

FIG. 6 is a cross-sectional view of a glass filter of a plasma display device according to the second embodiment.

Referring to FIG. 6, a substrate 11, a second pressure sensitive adhesive layer 15, a black frame layer 14, and a functional film layer 13 each correspond to the substrate 1, the second pressure sensitive adhesive layer 5, the black frame layer 4, and the functional film layer 3, so that the description thereof in the first embodiment may be recited as it is.

In the second embodiment, the electromagnetic waves shielding layer 12 may include a film layer and a conductive patterning layer 18. The electromagnetic waves shielding layer 12 can provide the conductive patterning layer 18 by coating conductive material exemplified as copper, etc. on the film layer 17 exemplified as PET using a electronic beam deposition method, a sputtering method, and a wet coating method, etc. The electromagnetic waves shielding layer 12 can be coated on the substrate 1 by a first pressure sensitive adhesive layer 16. The first pressure sensitive adhesive layer 16 may be made of the same material of the second pressure sensitive adhesive layer 15, however may also be provided in a state where only the binder and the solvent are included excepting the color correction dye and the near infrared ray blocking dye.

Differently from the first embodiment, in the second embodiment the first pressure sensitive adhesive layer 16 is interposed on the lower side of the substrate 11 to provide the electromagnetic waves shielding layer 12 so that the functional film layer 13 and the electromagnetic waves shielding layer 12 are individually attached to the front surface and the rear surface of the substrate 11 by means of the pressure sensitive adhesive. With the manufacturing method as described above, there is a disadvantage that one more process is required, however each layer provided on the upper side of the substrate 11 can obtain the same effects as those in the first embodiment. Furthermore, in the second embodiment, in the case where there is no need to harden the substrate 11, there is no need to pass through an expensive burning process, making it possible to remarkably reduce the material costs. In the case where the second embodiment has the same constitution as that of the first embodiment, the second embodiment maintains the advantages of the first embodiment as they are.

### THIRD EMBODIMENT

FIG. 7 is a cross-sectional view of a glass filter of a plasma display device according to the third embodiment.

Referring to FIG. 7, a substrate 21 and an electromagnetic waves shielding layer 22 each can be manufactured with the substrate 1 and the electromagnetic waves shielding layer 22 of the first embodiment so that the description in the first embodiment can be cited as it is.

In the third embodiment, a second pressure sensitive adhesive layer 25, a first functional film layer 27, a black frame layer 24, a first pressure sensitive adhesive layer 26, and a functional film layer 13 are stacked on a front surface of the substrate 21. In more detail, the second pressure sensitive adhesive layer 25 and the first pressure sensitive adhesive layer 26 each are for attaching the functional film layers 23 and 27, wherein in at least any one of the two pressure sensitive adhesive layers 26 and 25, the color correction dye and the near infrared ray blocking dye can be individually or together included in the same manner as the pressure sensitive adhesive layer 5 of the first embodiment. In the drawing of the present embodiment, the second pressure sensitive adhesive layer 25 is illustrated to include both of them.

The present embodiment may further include the modified examples below. First, the first functional film layer 27, which is the same layer as the functional film layer 3 of the first embodiment, can be provided as a hard film layer into which light reflection function is added. The black frame layer 24 may be provided on the rear surface side of the first functional film layer 27 and may be provided on the rear surface side of the second functional film layer 23. The first functional film layer 27 may be provided as a general film exemplified as PET not having a hard layer.

The manufacturing method of the glass filter according to the third embodiment will be described. Only the portions remarkably distinguished in the third embodiment will be described.

The first functional film layer 27 and the second functional film layer 23 formed on the boundary part of the black frame layer 24 are attached by the first pressure sensitive adhesive layer 26. During the attaching process, the black frame layer 24 is stably positioned on a predetermined position not to be affected by dirt from the external and the film can be stably moved and managed later. However, the black frame layer 24 may also be provide on the rear surface side of the first functional film layer 27 so that in this case, the second functional film layer 23 may be attached after the first functional film layer 27 is attached to the substrate 21.

In the third embodiment, there may be a disadvantage due to use of two or more functional films. However, there is an advantage in that there is no limit in selecting dye according to the deterioration in function by means of the interaction between the due or pigment of the black frame layer 24 and the color correction dye and the near infrared ray blocking dye of the second pressure sensitive adhesive layer 26—in this case, it is assumed that the color correction dye and the near infrared ray blocking dye are included in only the second pressure sensitive adhesive layer 26—. This is because that the dye or pigment of the black frame layer 24 is organic dye.

In the present embodiment, the black frame layer 24 may be preferably used according to the sort of plasma display device, having no limit in selection of dye or pigment. In the third embodiment, the same acting effects for the same constitution as that of the first embodiment can also be expected.

### FOURTH EMBODIMENT

FIG. 8 is a cross-sectional view of a glass filter of a plasma display device according to the fourth embodiment.

Referring to FIG. 8, a second functional film layer 40 is attached to the front surface of the substrate 31 by a third pressure sensitive adhesive layer 33, and a front surface protective film 8 is attached to the front surface of the second functional film layer 40. A hard film layer may be preferably use as the second functional film layer 40. A first functional film layer 39 is attached to the rear surface of the substrate 31 by a second pressure sensitive adhesive layer 35. A black frame layer 34 is formed on the rear surface of the first functional film layer 39, and an electromagnetic waves shielding layer 32 is formed on the rear surface thereof by a first pressure sensitive adhesive layer 36. Here, the electromagnetic waves shielding layer 32 may be provided in the same manner as that in the second embodiment.

Here, the color correction dye and the near infrared ray blocking dye may be selectively or together included in the pressure sensitive adhesive layers 36, 35, and 33. However, it will be preferable that the color correction dye and the near infrared ray blocking dye are not included in the pressure sensitive adhesive layer contacting the black frame layer in order to suppress the interaction of the dye. And, the electromagnetic waves shielding layer is the same as that in the second embodiment so that the description thereof in the second embodiment will be cited.

In the fourth embodiment, although problems arise due to a complicated process, the interaction between dyes can be reduced and the costs can be reduced since it is used when the substrate is not required to be hardened.

Also, in the fourth embodiment, when the substrate 31 can spontaneously control the reflection of external light as a reinforced substrate, the third pressure sensitive adhesive layer 33 and the second functional film layer 40 provide on the upper side of the substrate 31 can be removed.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

With the glass filter according to the present invention, the manufacturing process of the plasma display device having an intensive price competition becomes convenient and the manufacturing costs thereof are reduced, while maintaining the original function of the glass filter as it is, so that its market competitiveness can be more enhanced.

1. A plasma display device comprising:
a plasma display module;
a frame supporting the plasma display module;
a glass filter on whose rear the frame is fixed; and
a rear housing protecting the plasma display module in the rear thereof,
wherein the glass filter comprises:
a substrate:
a functional film layer on whose external surface a black frame layer defining an effective screen is formed;
a pressure sensitive adhesive layer adhering the functional film layer to the substrate; and
an electromagnetic waves shielding layer provided in the rear of the substrate and blocking electromagnetic waves generated from the plasma display module to transfer it to the frame.

2. The plasma display device according to claim 1, wherein the electromagnetic waves shielding layer is formed on the rear-most part of the substrate.

3. The plasma display device according to claim 1, wherein the pressure sensitive adhesive layer includes color correction dye and near infrared ray blocking dye.

4. The plasma display device according to claim 1, wherein the black frame layer is exposed to the pressure sensitive adhesive layer.

5. The plasma display device according to claim 4, wherein the black frame layer is printed.

6. The plasma display device according to claim 1, wherein the frame is attached to the rear surface of the glass filter.

7. The plasma display device according to claim 1, wherein the functional film layer is a hard film layer, the hard film layer including a film layer and a hard coating layer formed on the film layer.

8. The plasma display device according to claim 1, wherein the electromagnetic shielding layer is printed on the rear surface of the substrate.

9. The plasma display device according to claim 1, wherein at least one portion of the glass filter is exposed to the external.

10. The plasma display device according to claim 1, wherein the glass filter defines the front-most of the plasma display device.

11. A glass filter of a plasma display device, which is spaced forward from a plasma display module at a predetermined distance to perform a color correction function correcting deterioration of color purity, a near infrared ray blocking function blocking a near infrared ray generating malfunction of a remote controller, etc., an electromagnetic waves shielding function, an external light antireflection function, and a function defining an effective screen,
wherein the function defining the effective screen is performed by a functional film layer on whose external region a black frame layer is printed, the functional film layer being attached to the front surface of the substrate using an adhesive.

12 . The glass filter of the plasma display device according to claim 11, wherein the adhesive includes at least one of color correction dye and near infrared ray blocking dye.

13. The glass filter of the plasma display device according to claim 12, wherein the adhesive includes both color correction dye and near infrared ray blocking dye.

14. The glass filter of the plasma display device according to claim 11, wherein the adhesive is a pressure sensitive adhesive.

15. The glass filter of the plasma display device according to claim 11, wherein the electromagnetic shielding is performed by an electromagnetic waves shielding layer formed on the rear-most of the glass filter.

16. The glass filter of the plasma display device according to claim 11, wherein the functional film layer is a hard film layer, the hard film layer including a film layer and a hard coating layer formed on the film layer.

17. A manufacturing method of a glass filter of a plasma display device, in which a burning process of a substrate and a pattern provided by printing the substrate is performed at a once and a printing process of a black frame layer on one surface of a functional film layer is performed, respectively, and
the functional film layer is adhered to the substrate so that the electromagnetic wave shielding layer provided by the burning the pattern faces the rear.

18. The manufacturing method according to claim 17, wherein during the adhering, an pressure sensitive adhesive is used, the pressure sensitive adhesive including color correction dye and near infrared ray blocking dye.

19. The manufacturing method according to claim 17, wherein the substrate is adhered to the functional film layer so that the black frame layer faces the substrate.

20. The manufacturing method according to claim 17, wherein a protective film is attached to other surface of the functional film layer before the black frame layer is formed.
